(19) United States
(12) Patent Application Publication
(10) Pub. No.: US 2020/0205345 A1
(43) Pub. Date: Jul. 2, 2020

(54) WINDROWER AUTOMATIC CONTROLS FOR WINDROW FORMATION

(71) Applicant: AGCO Corporation, Duluth, GA (US)

(72) Inventors: Shane A. Bollinger, Hesston, KS (US); Keith Whitaker, Hesston, KS (US)

(21) Appl. No.: 16/731,368

(22) Filed: Dec. 31, 2019

Related U.S. Application Data
(60) Provisional application No. 62/786,613, filed on Dec. 31, 2018.

(51) Int. Cl. A01D 57/00

(52) U.S. Cl. CPC A01D 57/00; A01D 82/02

(57) ABSTRACT

In one embodiment, a system, comprising: an interface configured to receive input defining a target windrow; a windrower comprising a windrow forming assembly configured to form a windrow; one or more sensors; and a computing system configured to control formation of the windrow according to the target windrow based on the input and further based on input from the one or more sensors.

### CROSS REFERENCE TO RELATED APPLICATION

This application claims the benefit of U.S. Provisional Application No. 62/786,613, filed Dec. 31, 2018, which is hereby incorporated by reference in its entirety.

### TECHNICAL FIELD

The present disclosure is generally related to windrowers and, more particularly, control of windrow forming operations.

### BACKGROUND

Windrowers comprise harvesting machines that are equipped with one of several types of detachable headers having a cutter assembly (e.g., rotary or sickle-type) and a conditioning system, which may include one or more pairs of hydraulically-driven, oppositely rotating, conditioner rolls that are used to condition (e.g., crush, macerate) harvested crop material and deposit the conditioned crop material onto the ground as a swath or windrow (hereinafter, collectively referred to as a windrow). The conditioning process serves to facilitate drying of the crop material. The windrower comprises a windrow forming assembly, located behind the conditioner rolls, that helps define the width and/or shape of the windrow, the windrow forming assembly comprising a transverse extending swathboard, a tapered, fore and aft extending forming shield assembly, and/or a rear deflector. The swathboard may be rotated up or down to enable a windrow that ranges from a width that is uninfluenced by the forming shield assembly to one that is affected by the location of impact upon the forming shield. The rear deflector may be used to adjust the height of the windrow. Adjustments to the windrow forming assembly are generally performed by an operator at the onset of field operations, with the adjustment in settings based on experience with the hope that the operator has accurately anticipated crop conditions in a manner that optimizes the desired rate of crop dry-down.

### SUMMARY OF THE INVENTION

One object of the present invention is to provide a system that makes adjustments to a windrow forming assembly without overburdening an operator. To better address such concerns, in a first aspect of the invention, a system is disclosed that receives an input defining a target windrow and responsively controls windrow formation according to the defining input and further based on sensor input. The system thus automates windrow formation with the necessary adjustments based on sensor feedback to ensure windrow formation approximates (e.g., equals) the target windrow.

In one embodiment, the system comprises an interface configured to receive input defining a target windrow; a windrower comprising a windrow forming assembly configured to form a windrow; one or more sensors; and a computing system configured to control formation of the windrow. This combination of components brings about a windrow formation that approximates the target windrow and at the same time reduces the burden on an operator.

In one embodiment, the interface comprises a user interface located in the windrower. For embodiments where the interface resides within the windrower, the operator can input the target windrow, such as by selecting a width and/or among a plurality of graphics of windrow shapes and/or sizes that represent a desired windrow configuration and then rely on the system to enable the production of a windrow according to the requirements of the operator.

In one embodiment, the interface comprises a communications interface configured to receive the input from a remote device. In such remote-controlled embodiments, an operator may control one or more windrowers at several locations within a field or among plural fields through a suitable communications medium (e.g., cellular communications, wireless-fidelity (Wi-Fi), etc.), enabling autonomous or semi-autonomous farming to be achieved.

In one embodiment, the windrow forming assembly comprises one or more of a swathboard, forming shields, or a rear deflector. Control of any one or a combination of the windrow forming assembly components facilitates the formation of the windrow according to the requirements of the operator while reducing the guess-work conventionally required in windrow formation operations.

In one embodiment, based on the input defining the target windrow, the computing system is configured to set the one or more of the swathboard, the forming shields, or the rear deflector to respective first values to enable formation of a windrow with dimensions that approximate the target windrow. The system may access a look-up-table (LUT) of default values based on the entered target windrow, providing for automatic settings and reducing the labor burden of the operator based on operator definition of the desired windrow.

In one embodiment, based on the input from the one or more sensors, the computing system is configured to reduce any difference between the windrow formed according to the first values and the target windrow by setting the one or more of the swathboard, the forming shields, or the rear deflector to respective second values. The system receives feedback of performance in meeting the target windrow and hence provides for a dynamic and flexible control scheme that accounts for varying machine and/or crop conditions without burdening the operator.

These and other aspects of the invention will be apparent from and elucidated with reference to the embodiment(s) described hereinafter.

### BRIEF DESCRIPTION OF THE DRAWINGS

Many aspects of certain embodiments of the disclosure can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1 is a schematic diagram that illustrates, in side elevation view, an example windrower in which an embodiment of a windrow formation control system may be implemented.

FIGS. 2A-2B are schematic diagrams that illustrate, in fragmentary top plan and side elevation views, respectively, a windrow forming assembly that operates under control of an embodiment of a windrow formation control system.

FIG. 3 is a block diagram that illustrates an embodiment of an example windrow formation control system.

FIG. 4 is a flow diagram that illustrates an embodiment of an example windrow formation control method.

### DESCRIPTION OF EXAMPLE EMBODIMENTS

Certain embodiments of a windrow formation control system and associated method are disclosed that automatically adjust a windrow forming assembly of a windrower to achieve a windrow that meets a target windrow (e.g., windrow width, height, shape, etc.) as defined by the operator. In one embodiment, the operator inputs the targeted (required or desired) windrow (e.g., windrow width), and the windrow formation control system automatically maintains the windrow in a manner that approximates (e.g., matches) the target windrow by, for instance, setting positional values for components of the windrow forming assembly. In some embodiments, the windrow formation control system makes adjustments to additional machine controls to effect changes to the windrow formation including ground speed, header operational mechanisms (e.g., header tilt, cutting speed, conditioner roll speed, etc.). In one embodiment, the windrow forming assembly may comprise one or any combination of a swathboard, forming shields, or a rear deflector. The windrow formation control system monitors the windrow formation performance and in some embodiments, machine and/or environmental conditions, using one or more sensors, which may include one or more cameras, LIDARs, among other sensors (e.g., ground speed sensors, header operation sensors, crop height sensors, etc.). Based on the monitoring, adjustments to one or more settings of the components of the windrow forming assembly may be made to reduce any error between the target windrow and the actual windrow (e.g., to ensure an actual width that approximates the target width).

Digressing briefly, in most harvesting operations, an operator manually sets certain windrow forming assembly components according to the desired windrow (e.g., specific target dimensions) to be produced by the windrower. However, settings of header angle, swathboard, crop forming shields, and rear deflector, among other conditions, can affect these dimensions in a manner that results in the operator not achieving the desired windrow. In certain embodiments of a windrow formation control system, the control system is first provided a defined output (target windrow) and automatically sets the windrow forming assembly to achieve the targeted windrow, with adjustments made based on feedback input from one or more sensors that monitor performance, resulting in less burden to the operator and more consistency in windrow formation. That is, having a more consistent windrow may produce more consistent crop conditions and moisture levels, which may be important from a silage and baling perspective, as it improves the feed quality for livestock. For instance, having a wet bale from a heavier windrow next to a dry bale from a lighter windrow may lead to challenges for storage (e.g., the wet bale may spoil) and inconsistent feed quality, conditions which certain embodiments of a windrow formation control system addresses.

Having summarized certain features and/or benefits of a windrow formation control system of the present disclosure, reference will now be made in detail to the description of a windrow formation control system as illustrated in the drawings. While a windrow formation control system will be described in connection with these drawings, there is no intent to limit it to the embodiment or embodiments disclosed herein. For instance, though emphasis is placed on a self-propelled windrower, certain embodiments of a windrow formation control system may be beneficially deployed in pull-type windrowers or other harvesting machines that use a windrow forming assembly. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the windrower looking forwardly.

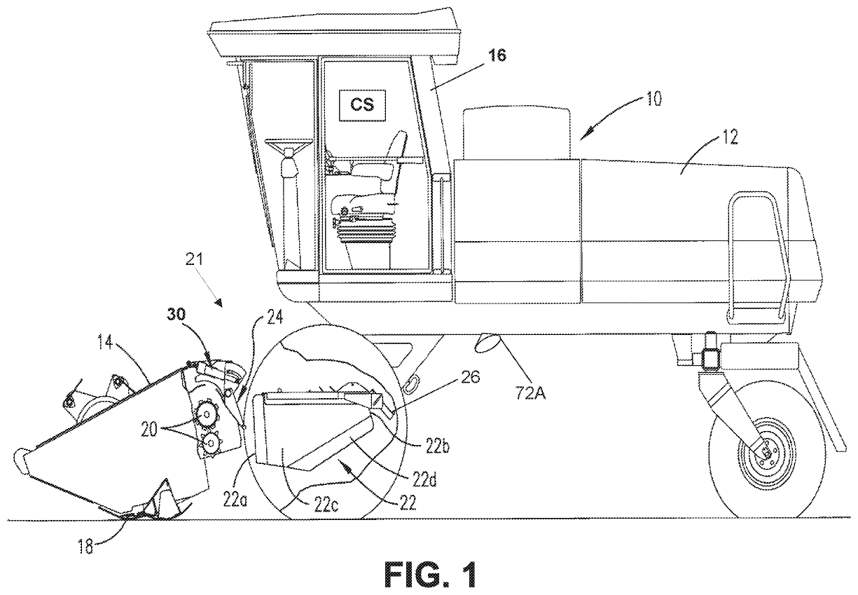

Referring now to FIG. 1, shown is an example harvesting machine in the form of a self-propelled windrower 10, in which an embodiment of a windrow formation control system may be implemented. Though described as a self-propelled windrower 10, in some embodiments, other harvesting machines may be used including pull-type windrowers or other types that form a windrow. The windrower 10 broadly comprises a self-propelled tractor 12 and a harvesting header 14 attached to the front of the tractor 12. The operator drives the windrower 10 from a cab 16, which includes an operator station comprising a tractor seat and one or more user interfaces (e.g., FNR joystick, display monitor, switches, buttons, etc.) that enable the operator to control various functions of the tractor 12 and the header 14. In one embodiment, a computing system (denoted “CS” in FIG. 1 and described further below) is disposed in the cab 16, though in some embodiments, the computing system may be located elsewhere or comprise a distributed architecture having plural computing devices, coupled to one another in a network, throughout various locations within the tractor 12 (or in some embodiments, located in part externally and in remote communication with one or more local computing devices).

The header 14 includes a cutter 18 for severing standing crops as the windrower 10 moves through the field, a conditioning system that, in the depicted embodiment, comprises one or more pairs of conditioner rolls 20, and a windrow forming assembly 21. In some embodiments, the conditioning system may be of a different design, including the use of a flail type conditioning system. In one embodiment, the windrow forming assembly 21 comprises a pair of rearwardly converging windrow forming shields 22 located behind the conditioner rolls 20, a swathboard 24 located between the conditioner rolls 20 and the forming shields 22, and a rear deflector 26 adjacent a top side and rearward of the forming shields 22. In some embodiments, the windrow forming assembly 21 may comprise fewer or additional components. In self-propelled machines, the forming shields 22 are typically supported partly by the header frame and partly by the tractor 12, while in pull-type machines, the forming shields are typically carried on the header frame only. In some embodiments, the forming shield assembly may be differently configured (e.g., using a single shield or additional shields of the same or different geometric configuration), as long as the result is providing the windrow according to a defined width/shape.

The conditioner rolls 20, depicted in FIG. 1 as a single pair (though an additional pair may be used in some embodiments), have a characteristic of projecting a stream of conditioned materials rearwardly therefrom and toward the windrow forming assembly 21 as the crop materials issue from the rolls 20. If the swathboard 24 is fully raised, the stream bypasses the swathboard 24 and is acted upon by the shields 22 and the rear deflector 26 to form a windrow in accordance with the adjusted positions of the forming shields 22 and rear deflector 26. On the other hand, if the swathboard 24 is fully lowered, as illustrated in FIG. 1, the stream will be intercepted by the swathboard 24 and directed down to the ground without ever engaging the forming shields 22 or rear deflector 26. Consequently, a wide swath will be formed.

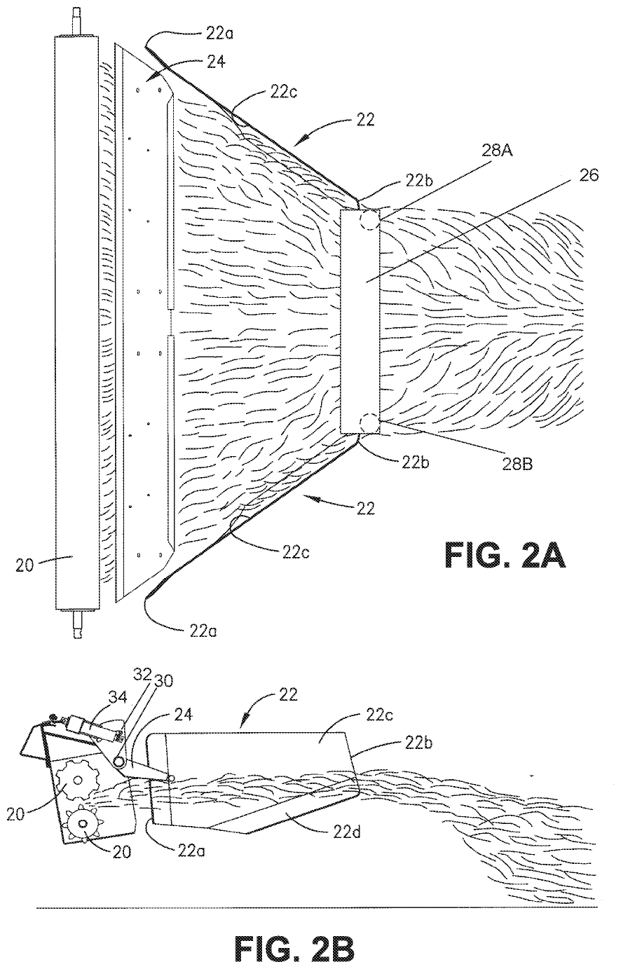

With continued reference to FIG. 1, and referring to FIGS. 2A and 2B, each of the forming shields 22 has a front end 22a, a rear end 22b, and an elongated deflecting surface 22c extending between the front and rear ends 22a and 22b. The front ends 22a of the shields 22 are spaced apart by a distance that substantially corresponds to the width of the conditioner rolls 20 in a direction extending transversely to the path of travel of the windrower 10, while the rear ends 22b of the shields 22 are spaced apart by a distance that is substantially less than such width. Consequently, it will be appreciated that the shields 22 converge rearwardly (e.g., tapered), somewhat in the nature of a funnel to correspondingly taper down the stream of crop materials issuing from the conditioner rolls 20 and impinging upon the shields 22. In one embodiment, the front ends 22a of the shields 22 flare outwardly to a slight extent, while the lower rear margins 22d of the shields 22 are curled slightly inwardly, though other configurations may be used.

As is known, the shields 22 are supported by a frame that includes a pair of fore-and-aft, rearwardly converging members and a top wall (the known member and top wall structures omitted in this view). The shields 22 are pivoted at their front ends 22a to the members by pivots and are adjustably supported by the top wall near their rear ends 22b by fasteners. The fasteners pass through intersecting slots in the top wall and the forming shields 22 respectively, and are coupled to a respective actuator 28 (e.g., 28A, 28B), best shown in FIG. 2A, that enables the shields 22 to be adjusted (pivoted at pivots) to narrow or widen the impact point of crop material projected onto the shields 22. In one embodiment, the actuators 28 contains a small, reversible electric motor which drives a worm gear (not shown) to extend and retract a moving component (e.g., the rod) of the actuator to enable adjustment of the shields 22 via attachment to the fasteners. Though described in the context of an electrical/electromechanical actuator, the actuator 28 may be configured according to other linear or rotary technologies in some embodiments, including hydraulic, pneumatic, magnetic, and electromagnetic. Further, in some embodiments, a single actuator 28 may be used, where movement of the opposing shield may be effected via a linkage among the fasteners.

The swathboard 24 is fixed to a transversely extending tube 30. A crank 32 is fixed to the tube 30 and projects upwardly therefrom for rotating the crank 32 and thus the swathboard 24 between the fully raised and fully lowered position. In one embodiment, an actuator 34 in the form of an electromechanical device is operably connected between the crank 32 and a mounting lug (not shown) on the frame of the header 14. The actuator 34 contains a small, reversible electric motor which drives a worm gear (not shown) to extend and retract a moving component (e.g., the rod) of the actuator. Though described in the context of an electrical/electromechanical actuator, the actuator 34 may be configured according to other linear or rotary technologies in some embodiments, including hydraulic, pneumatic, magnetic, and electromagnetic. Additional information about the known structures of the swathboard 24 and an example forming shield assembly may be found in commonly assigned, U.S. Pat. No. 5,930,988, which is incorporated by reference in its entirety.

The rear deflector 26 (omitted from view in FIG. 2B and shown in fragmentary view in FIG. 2A) may be positioned up or down by a similar mechanism used by the swathboard 24 (e.g., crank arm, tube assembly, and actuator), though other mechanisms may be used.

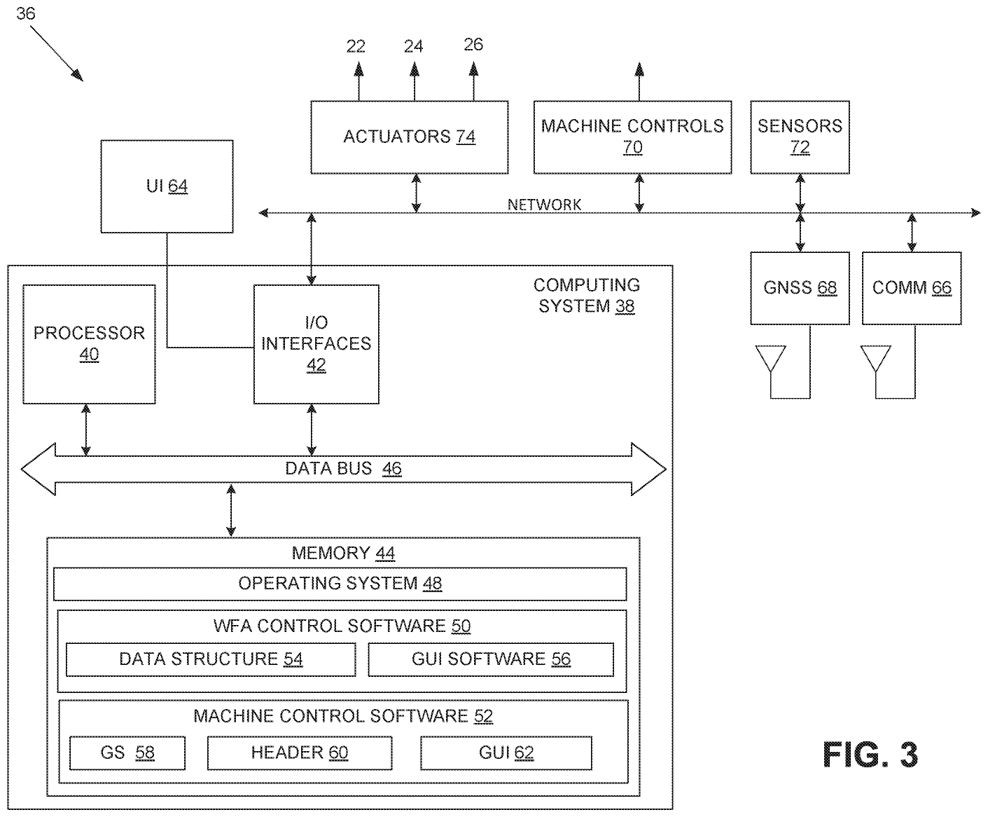

With continued reference to FIGS. 1-2B, attention is directed to FIG. 3, which shows embodiment of an example windrow formation control system 36. One having ordinary skill in the art should appreciate in the context of the present disclosure that the example windrow formation control system 36 is merely illustrative, and that some embodiments may comprise fewer or additional components, and/or some of the functionality associated with the various components depicted in FIG. 3 may be combined, or further distributed among additional modules and/or computing devices (e.g., plural ECUs), in some embodiments. It should be appreciated that, though described primarily in the context of residing in the windrower 10 (FIG. 1), in some embodiments, one or more of the functionality of the windrow formation control system 36 may be implemented in a computing device or devices internal and external to the windrower 10, or completely external to the windrower 10. The windrow formation control system 36 comprises a computing system 38 communicatively coupled to plural components via a network. The computing system 38 is depicted in this example as a computer device (e.g., an electronic control unit or ECU), but may be embodied as a programmable logic controller (PLC), field programmable gate array (FPGA), application-specific integrated circuit (ASIC), among other devices, including implemented as plural devices. It should be appreciated that certain well-known components of computer systems are omitted here to avoid obfuscating relevant features of the computing system 38. In one embodiment, the computing system 38 comprises one or more processors, such as processor 40, input/output (I/O) interface(s) 42, and memory 44, all coupled to one or more data busses, such as data bus 46. The memory 44 may include any one or a combination of volatile memory elements (e.g., random-access memory RAM, such as DRAM, and SRAM, etc.) and nonvolatile memory elements (e.g., ROM, Flash, hard drive, EPROM, EEPROM, CDROM, etc.). The memory 44 may store a native operating system, one or more native applications, emulation systems, or emulated applications for any of a variety of operating systems and/or emulated hardware platforms, emulated operating systems, etc.

In the embodiment depicted in FIG. 3, the memory 44 comprises an operating system 48, windrow forming assembly (WFA) control software 50 and machine control software 52. In one embodiment, the windrow forming assembly control software 50 comprises a data structure 54 (e.g., look up table or LUT) and graphical user interface (GUI) software 56. The machine control software 52 comprises plural software to control functioning of the windrower 10, including ground speed control software (GS) 58, header operation control software (HEADER) 60, and GUI software (GUI) 62. In some embodiments, functionality of one or more of these components of the windrow forming assembly control software 50 and/or the machine control software 52 may be located elsewhere (e.g., the data structure may be located in a persistent storage device external to memory 44, functionality for the software 50 and/or 52 or one or more components thereof may be located remotely, or distributed among the windrower 10 and remote computing devices), combined, or omitted (e.g., the data structure 54 may not be used, instead using (parametric) equations). In one embodiment, the windrow forming assembly control software 50 comprises functionality for the control of components of the windrow forming assembly 21, and the machine control software 52 comprises functionality for the control of one or more machine controls for the windrower 10, including ground speed (via ground speed control software 58) and header operations (e.g., header tilt, cutter speed, conditioner roll operations, etc.) via header operation control software 60.

It should be appreciated that in some embodiments, additional modules (e.g., browser, or if functionality of the windrow forming assembly control software 50 and/or machine control software 52 is located remotely, web-host network software, guidance software, automated steering control, communications software, etc.) or fewer software modules (e.g., combined functionality, omitted functionality) may be employed (or omitted) in the memory 44 or used in additional memory. In some embodiments, a separate storage device may be coupled to the data bus 46 (or to a controller area network (CAN) bus (depicted in FIG. 3 as NETWORK, including a CAN system, such as a network in conformance to the ISO 11783 standard, also referred to as “Isobus) or other network via I/O interfaces 42), such as a persistent memory (e.g., optical, magnetic, and/or semiconductor memory and associated drives).

The I/O interfaces 42 provide one or more interfaces to the CAN bus (NETWORK) and/or other networks. In other words, the I/O interfaces 42 may comprise any number of interfaces for the input and output of signals (e.g., comprising analog or digital data) for conveyance of information (e.g., data) over one or more networks. The input may comprise input by an operator residing in the cab 16 of the windrower 10 through the user interface 64, which may include switches, touch-screen, FNR joystick, keyboard, steering wheel, headset, immersive headset, mouse, microphone/speaker, display screen, among other types of input devices. In some embodiments, input via the I/O interfaces 42 may additionally or alternatively be received from a remote device. For instance, remote control of windrower operations may be achieved via control signals communicated from a remote device to a communications interface 66 coupled to the network, which in turn provides a communications medium (e.g., wired and/or wireless) by which data is transferred to the computing system 38 via the I/O interfaces 42. The communications interface 66 may comprise one or more antennas, a radio modem, cellular modem, wireless modem, or a combination of these components. The communications interface 66 may cooperate with communications software (not shown) residing in memory 44 (e.g., GSM protocol stack, 802.11 software, etc.) to enable the transmission and/or reception of data (e.g., commands) over a cellular or wireless local area network (LAN). Input data received by the computing system 38 via the I/O interfaces 42 may also include positional or location data, including data received from a GNSS (global navigation satellite systems) receiver 68 coupled to the CAN or other network. Guidance software located in memory 44 may be used in conjunction with automated steering control software to actuate steering mechanisms of machine controls 70 (e.g., steering cylinders in conjunction with steering valve actuators/valves or motors) for autonomous or semi-autonomous steering control of the windrower 10. In some embodiments, positional or location information may be achieved through other techniques, including triangulation using the communications interface 66 or dead-reckoning techniques via inertial components (e.g., accelerometers, gyroscopes, etc.). Sensors 72 are also coupled to the network and provide input to the computing system 38 via I/O interfaces 42. In one embodiment, sensors 72 include ground speed sensors, positional sensors, angle sensors (e.g., rotary encoders), load sensors, acoustic sensors, and/or optical sensors (e.g., array or strip sensors, LIDAR, cameras). For instance, one or more optical sensors, such as optical sensor 72A (e.g., camera, LIDAR), may be disposed beneath the windrow frame (see FIG. 1) to detect the shape and/or dimensions of the windrow, as explained further below. The sensors 72 may be used to detect and provide feedback of the position of components of the windrow forming assembly 21 and/or machine controls 70. For instance, sensors 72 may comprise header operation sensors, including sensors used to detect header tilt, crop height, conditioner roll speed, conditional roll gap, impact forces on components of the windrow forming assembly 21, etc. In some embodiments, sensors 72 may be integrated in part in cylinders of actuators 74. Actuators 74 may include actuators 28, 34, and actuators for the rear deflector 26. As used herein, actuators 74 include a triggering portion (e.g., electromagnetic portion, such as a solenoid or motor, though other forms of control including hydraulics or pneumatics may be used) and an extending/retracting portion (e.g., actuation of the trigger portion triggers rotation or linear motion of a rod or piston). In some embodiments, the actuators 74 may include one or more valves with an electromagnetic component (solenoid, or hydraulic or pneumatic-based control) that adjusts a poppet or spool of the valve, which in turn regulates fluid flow through a respective hydraulic or pneumatic cylinder comprising a rod or piston component that mechanically actuates a pivotable or linear-acting component (e.g., forming shield 22, swathboard 24, rear deflector 26, etc.). The computing system 38 signals one or more of the actuators 74 to extend or retract, which in turn adjusts the forming shields 22, swathboard 24, and/or rear deflector 26 to form a windrow to approximate or match a target windrow defined by an operator.

Returning to operation of the computing system 38, the windrow forming assembly control software 50 comprises a data structure 54 (e.g., look up table or LUT) and graphical user interface (GUI) software 56. The data structure 54 comprises one or more default settings (e.g., predefined values) for components of the windrow forming assembly 21 based on various conditions (e.g., crop conditions, including crop height, crop density, etc.) and machine state (e.g., windrower (average) speed). Depending on crop conditions and the desired rate of crop dry down to reduce moisture, the operator chooses the desired windrow width. For instance, an operator may enter a desired windrow (target windrow) at an entry box or window within the user interface 64 as rendered on a monitor (e.g., display screen) via the GUI software 56. In some embodiments, the target windrow may be entered by an operator via verbal commands, or selected by the operator from a rendered list of default windrow options. The target windrow may be inputted as a target width in one embodiment, where the shape and/or other dimensions (e.g., height) comprise default values to be based on the inputted width. In some embodiments, the GUI software 56 may render a list of windrow graphics of varying shapes and/or dimensions that the operator selects on the screen. In some embodiments, the operator may enter and/or select width, height, and/or radius of the top surface of the windrow (e.g., shape, such as flat or rounded).

Upon input of the target windrow, in one embodiment, the windrow forming assembly control software 50 accesses the data structure 54 for settings for the given target windrow, and/or applies the settings accessed from the data structure 54 to the windrow forming assembly 21. The windrow width for a given crop condition is affected by several machine parameters such as ground speed, swathboard position, forming shield position and rear deflector position. The windrow forming assembly control software 50 may cause (via actuators 74) rotation of the swathboard 24 down to direct the conditioned crop (discharged from the condition rolls 20) into a wide swath (e.g., based on the selected settings according to the target windrow). A wider swath provides maximum sun and air exposure to dry the hay. Likewise, the windrow forming assembly control software 50 may cause rotation of the swathboard 24 all the way up and out of the path of the crop to decrease the width of the windrow and enable the narrowest windrow (e.g., based on the settings corresponding to the target windrow).

The forming shields 22 and rear deflector 26 are used to form a windrow of one of a variety of varying widths to fit varying crop conditions according to the defined target windrow. The forming shield 22 can be adjusted by the windrow forming assembly control software 50 to make the windrow wider in heavy crop or narrower in light crop. Adjusting the forming shields 22 out to the wide position moves them out of the path of the crop and makes for a wider windrow. This is common in heavier crop conditions. The windrow forming assembly control software 50 may cause adjustment of the forming shields 22 inward to the narrowest position to make the narrowest windrow and maximum windrow height, which is used primarily in light crop conditions.

The rear deflector 26 may be adjusted by the windrow forming assembly control software 50 according to the settings corresponding to the target windrow to slow the crop, which lets the crop free fall to the ground in a loose windrow. Adjusting the deflector 26 up provides a taller, narrower windrow. Adjusting the deflector down, such in a light crop condition, provides a wider windrow.

Ground speed can also affect windrow formation. Slower ground speeds make the windrow wider. Higher ground speeds make the windrow narrower. Thus, in some embodiments, the windrow forming assembly control software 50 cooperates with the machine control software 52 to cause adjustments of the ground speed to achieve the desired target windrow.

In some embodiments, the target windrow may be selected based on historical data. For instance, upon a windrower 10 entering a field on a certain date, the windrow forming assembly control software 50 may detect entry upon the field (e.g., using the GNSS receiver 68) and access from memory 44 (or other storage, which may include remote storage accessed via the communications interface 66) the data structure 54 (or other data structure) for past settings for the windrow forming assembly 21 based on the location and date or range of dates (e.g., season). In other words, the windrow forming assembly control software 50 makes use of a geofence for the determination of default settings pertaining to a target windrow historically used for this geofence. Upon finding a match to the field and date range, the windrow forming assembly control software 50 may use these historical settings (e.g., previously defined) for the current default settings (for the target windrow) of the windrow forming assembly 21.

As the windrower 10 begins harvest operations along the field according to the default settings of the windrow forming assembly 21, the windrow forming assembly control software 50 repeatedly (e.g., continuously, periodically, aperiodically) receives feedback of the actual windrow formation via input from the sensors 72. The windrow forming assembly control software 50 uses this feedback to make corrections that reduce or eliminate the error between the target windrow and the actual windrow. In other words, the windrow forming assembly control software 50 makes adjustments to the initial setting values of one or more of the components of the windrow forming assembly 21 (and/or possibly machine controls 70) to ensure that the actual windrow formation approximates (e.g., matches) the target windrow (e.g., of the same width, shape, etc.). In one embodiment, the windrow forming assembly control software 50 receives feedback from one or more optical sensors 72A (e.g., camera, LIDAR), the optical sensor(s) 72A capturing a real time (e.g., immediate) image of the current windrow and, using known image/LIDAR processing/statistics, the windrow forming assembly control software 50 determines one or more dimensions (e.g., including the top surface radius or shape) of the windrow and adjusts one or more components of the windrow forming assembly 21. For instance, if the sensor feedback indicates that the windrow is narrower than the target width, the windrow forming assembly control software 50 may make setting adjustments to cause one or any combination of the following: reduce operating speed, rotate the swathboard 24 down, adjust the forming shields 22 to their wide position, and/or adjust the rear deflector 26 downward. If the sensor feedback indicates that the windrow is wider than the target width, the windrow forming assembly control software 50 causes the opposite adjustments to be made by adjusting the settings of one or any combination of the aforementioned (four) parameters to narrow the windrow. These adjustment in settings are translated (e.g., via a look-up-table or LUT or algorithmically) to stroke lengths of the actuators 74 (e.g., using control values, including 4-20 ma signals, 0-5V signals, etc.). As noted above, these adjustments may be performed to individual components based on one or more rules administered by the use of the look-up table (e.g., data structure 54) or other data structures. For instance, if feedback from the sensors 72 indicates that the measured windrow width is narrower than the preset (target) windrow width, the windrow forming assembly control software 50 may cause actuation of the actuator 74 responsible for rotating the swathboard 24 (e.g., downward). If the target windrow has a different height than the actual windrow height (according to sensor feedback), the windrow forming assembly control software 50 may cause actuation of the actuator 74 responsible for the rear deflector motion (e.g., adjusting the deflector 26 up to procure a taller, narrower windrow). In some embodiments, these dynamic adjustments to approximate (e.g., match) the target windrow may be achieved by the windrow forming assembly control software 50 using statistics to narrow the difference between actual and targeted windrows, or in some embodiments, using a set of rules in conjunction with a LUT (e.g., the data structure 54), or in some embodiments, performed algorithmically (e.g., using machine learning, parametric equations, etc.).

The machine control software 52 includes the ground speed control software 58, header operation control software 60, and GUI software 62. The ground speed control software 58 may receive input from sensors 72 (e.g., ground speed sensors) that indicate the current speed of the windrower 10. The windrow forming assembly control software 50 may cooperate with the ground speed control software 58 to communicate instructions to the machine controls 70 to lower or increase ground speed to narrow or reduce the difference between the target windrow and the actual windrow. Such corrections may be achieved without causing adjustments to settings for the windrow forming assembly 21 or in conjunction with adjustments of settings for the windrow forming assembly 21. In some embodiments, the windrow forming assembly control software 50 may cooperate with the header operation control software 60 to communicate instructions to the machine controls 70 to lower or increase the header height (e.g., cause adjustment of header tilt via actuation of tilt cylinders). For instance, the windrow target may not be achieved due to insufficient harvest density (e.g., as supplemented or affirmed by sensing of crop height in some embodiments), and the header operation control software 60 may (e.g., via cooperation with the windrow forming assembly control software 50) cause the tilt cylinders of the machine controls 70 to increase the tilt to lower the header height to improve harvesting yield. As is known, header tilt is achieved by an operator manually activating a switch in the cab 16, which in turn causes activation of one or more control valves of a manifold to change the flow of hydraulic fluid through a (e.g., double-acting) hydraulic cylinder used to cause a tilt of the header 14.

Note that an operator may use the tilt function from time-to-time during harvesting operations to avoid obstacles (e.g., gopher mounds) in the field and/or, as suggested above, to improve the harvesting action of the header 14 (e.g., when rain or winds have depressed crop material, requiring the tilt to lift the depressed crop material to improve the cutting action). For instance, though tilts may narrow any gap between the actual and target windrow, in some instances, the use of tilts in the header 14 may cause the crop material to impact the forming shields 22 more forwardly along the shields 22, resulting in a wider windrow than anticipated, or result in a discharge that has non-linear effects due to a transition between impact directly to the ground and impact onto the shields 22. The windrow forming assembly control software 50 may compensate for any deviations from the target windrow by making adjustments to the windrow forming assembly 21.

The status of the machine controls (e.g., windrower speed, header position, etc.) may be detected by the sensors 72 (e.g., ground speed sensors, or header operation sensors such as tilt sensors) and communicated to the operator via the GUI software 62 rendered on (or communicated via) the user interface 64. As noted above, the presentation to the operator may be achieved via one or any combination of a user interface 64 embodied as a display screen, microphone/speaker, and/or headset, including use of virtual or augmented reality based technology.

Execution of the windrow forming assembly control software 50 and the machine control software 52 (among other software of the computing system 38) may be implemented by the processor 40 under the management and/or control of the operating system 48. The processor 40 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing system 38.

When certain embodiments of the computing system 38 are implemented at least in part as software (including firmware, middleware, op-code, etc.), as depicted in FIG. 3, it should be noted that the software can be stored on a variety of non-transitory computer-readable medium (including memory 44) for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the computing system 38 are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

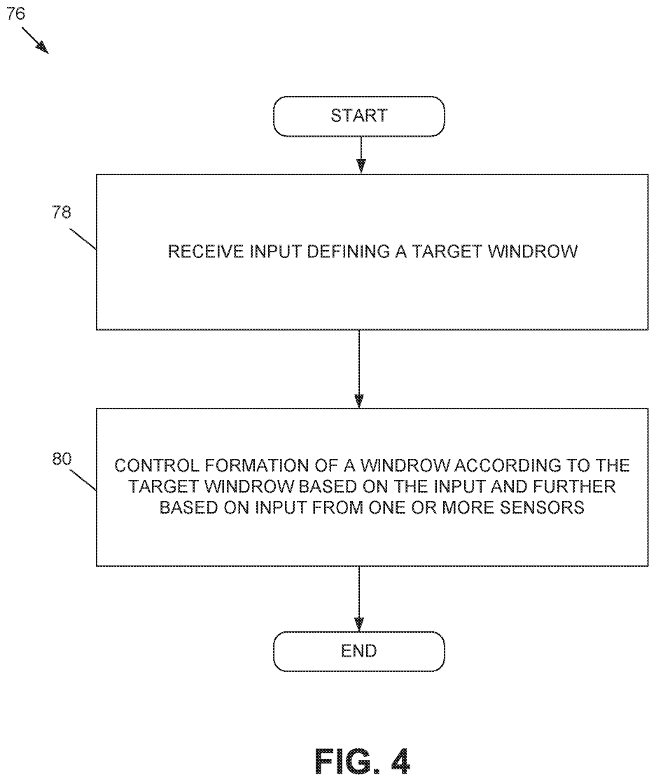

In view of the above description, it should be appreciated that one embodiment of an example windrow formation control method 76, depicted in FIG. 4 (and implemented in one embodiment by the computing system 38 and one or more other components depicted in FIG. 3), comprises receiving input defining a target windrow (78); and controlling formation of a windrow according to the target windrow based on the input and further based on input from one or more sensors (80).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. For instance, though certain embodiments of a windrow formation control system are described in the context of making adjustments automatically to approximate the actual windrow to the target windrow, in some embodiments, operator intervention may be implemented before any adjustments in settings are performed. For instance, in the case of header control, the decision to tilt the header (and hence change header height) may lead to a prompt or alert presented to the operator to provide an opportunity for the operator to deny such a change. In these instances, other actions may be taken by the windrow forming assembly control software 50, alone or in combination with the machine control software 52, to effect adjustments to approximate the target windrow. In some embodiments, the provision for operator intervention leading to denial by the operator of the intended remedial action may result in a failure to match the target windrow, and/or in some embodiments, the opportunity for operator intervention may have an expiration time, after which the action is implemented automatically (or vice versa). Although the systems and methods have been described with reference to the example embodiments illustrated in the attached drawing figures, it is noted that equivalents may be employed and substitutions made herein without departing from the scope of the disclosure as protected by the following claims.

At least the following is claimed:

1. A system, comprising:
an interface configured to receive input defining a target windrow;
a windrower comprising a windrow forming assembly configured to form a windrow;
one or more sensors; and
a computing system configured to control formation of the windrow according to the target windrow based on the input and further based on input from the one or more sensors.

2. The system of claim 1, wherein the interface comprises a user interface located in the windrower.

3. The system of claim 1, wherein the interface comprises a communications interface configured to receive the input from a remote device.

4. The system of claim 1, wherein the windrow forming assembly comprises one or more of a swathboard, forming shields, or a rear deflector.

5. The system of claim 4, wherein based on the input defining the target windrow, the computing system is configured to set the one or more of the swathboard, the forming shields, or the rear deflector to respective first values to enable formation of a windrow with dimensions that approximate the target windrow.

6. The system of claim 5, wherein based on the input from the one or more sensors, the computing system is configured to reduce any difference between the windrow formed according to the first values and the target windrow by setting the one or more of the swathboard, the forming shields, or the rear deflector to respective second values.

7. The system of claim 1, wherein the one or more sensors comprises a single sensor, the single sensor comprising a camera or a lidar.

8. The system of claim 1, wherein the one or more sensors comprises one or more cameras and one or more lidars.

9. The system of claim 8, wherein the one or more sensors further comprises one or any combination of one or more ground speed sensors or one or more header operation sensors.

10. The system of claim 1, wherein the computing system comprises one or more controllers.

11. The system of claim 1, wherein the computing system is located remote from the windrower.

12. The system of claim 1, wherein the computing system resides on the windrower.

13. The system of claim 1, wherein the target windrow comprises one or more target dimensions.

14. The system of claim 13, wherein the one or more target dimensions comprises width, height, or curvature of a top layer of the windrow.

15. A computer-implemented method, comprising:
receiving input defining a target windrow; and
controlling formation of a windrow according to the target windrow based on the input and further based on input from one or more sensors.

16. The method of claim 15, wherein controlling formation of the windrow comprises setting one or more of a swathboard, forming shields, or a rear deflector.

17. The method of claim 16, wherein controlling formation of the windrow comprises setting the one or more of the swathboard, the forming shields, or the rear deflector to respective first values to enable formation of a windrow with dimensions that approximate the target windrow.

18. The method of claim 17, wherein controlling formation of the windrow comprises adjusting the settings to reduce any difference between the windrow formed according to the first values and the target windrow, the adjustment of the settings occurring to the one or more of the swathboard, the forming shields, or the rear deflector according to respective second values based on the input from the one or more sensors.

19. The method of claim 15, wherein the target windrow comprises one or more target dimensions, the one or more target dimensions comprising width, height, or curvature of a top layer of the windrow.

20. A non-transitory computer-readable medium encoded with instructions that cause one or more processors to:
receive input defining a target windrow; and
control formation of a windrow according to the target windrow based on the input and further based on the input from one or more sensors, the formation controlled by causing adjustment of settings of one or more of a swathboard, forming shields, or a rear deflector.
